(19) United States
(12) Patent Application Publication
(10) Pub. No.: US 2024/0338136 A1
(43) Pub. Date: Oct. 10, 2024

(54) STORAGE DEVICE READING AND WRITING COLD DATA BASED ON IDENTIFIER AND OPERATING METHOD OF THE STORAGE DEVICE

(71) Applicant: SK hynix Inc., Gyeonggi-do (KR)

(72) Inventors: Seung Soo KIM, Gyeonggi-do (KR); Hyeong Jae CHOI, Gyeonggi-do (KR)

(21) Appl. No.: 18/451,119

(22) Filed: Aug. 17, 2023

(30) Foreign Application Priority Data
Apr. 10, 2023 (KR) 10-2023-0046550

(51) Int. Cl. G06F 3/06

(52) U.S. Cl. CPC G06F 3/064; G06F 3/0604; G06F 3/0673

(57) ABSTRACT

A storage device may receive a write command which requests to write target data and includes an identifier for the target data, a size of the target data, and a flag indicating that the target data is cold data. The storage device may write the target data to one or more consecutive target memory blocks among the plurality of memory blocks.

### CROSS-REFERENCES TO RELATED APPLICATION

The present application claims priority under 35 U.S.C. 119 (a) to Korean patent application number 10-2023-0046550 filed on Apr. 10, 2023, which is incorporated herein by reference in its entirety.

### BACKGROUND

### 1. Technical Field

Various embodiments of the present disclosure generally relate to a storage device which reads and writes cold data based on an identifier, and operating method thereof.

### 2. Related Art

A storage device is a device which stores data on the basis of a request from an external device such as a computer, a mobile terminal such as a smartphone and a tablet, or various electronic devices.

The storage device may include a controller for controlling a memory (e.g., a volatile memory/a nonvolatile memory). The controller may receive a command from the external device, and may execute or control an operation for reading, writing or erasing data with respect to the memory included in the storage device, on the basis of the received command.

Meanwhile, the type of data written in the memory may be classified into hot data, warm data and cold data. Among them, data that is unlikely to be modified after being written once (e.g., write-once-read-only multimedia file) may be classified as cold data.

### SUMMARY

Embodiments of the present disclosure may provide a storage device and an operating method thereof capable of improving the performance of a read operation and a write operation for cold data.

In one aspect, embodiments of the present disclosure may provide a storage device including a memory including a plurality of memory blocks, and a controller configured to write the target data to consecutive target memory blocks among the plurality of memory blocks, when receiving a write command which requests to write the target data and includes an identifier for the target data, a size of the target data, and a flag indicating that the target data is cold data.

In another aspect, embodiments of the present disclosure may provide a method for operating a storage device including receiving a write command which requests to write target data and includes an identifier for the target data, size of the target data and a flag indicating that the target data is cold data, determining consecutive target memory blocks among the plurality of memory blocks, and writing the target data to the target memory blocks.

In another aspect, embodiments of the present disclosure may provide an operating method of a controller including controlling, in response to an access request for target data, a memory device to access consecutive memory blocks related to the target data. The access request may include an indication that the target data is cold data.

According to the embodiments of the present disclosure, it is possible to improve the performance of read operation and write operation for cold data.

### BRIEF DESCRIPTION OF THE DRAWINGS

FIG. 1 is a schematic configuration diagram of a storage device according to an embodiment of the present disclosure.

FIG. 2 is a block diagram schematically illustrating a memory of FIG. 1.

FIG. 3 illustrates an operation in which a storage device processes write command according to embodiments of the present disclosure.

FIG. 4 illustrates an example of write command according to embodiments of the present disclosure.

FIG. 5 illustrates an operation in which a storage device writes target data according to embodiments of the present disclosure.

FIG. 6 illustrates an operation in which a storage device processes a read command according to embodiments of the present disclosure.

FIGS. 7 and 8 illustrate an operation in which a storage device reads target data according to embodiments of the present disclosure.

FIG. 9 illustrates an operation in which a storage device evicts a map unit cached in a map cache according to embodiments of the present disclosure.

FIG. 10 is a flowchart for describing an operating method of a storage device according to embodiments of the present disclosure.

### DETAILED DESCRIPTION

Hereinafter, embodiments of the present disclosure are described in detail with reference to the accompanying drawings. Throughout the specification, reference to “an embodiment,” “another embodiment” or the like is not necessarily to only one embodiment, and different references to any such phrase are not necessarily limited to the same embodiment(s). The term “embodiments” when used herein does not necessarily refer to all embodiments.

Various embodiments of the present invention are described below in more detail with reference to the accompanying drawings. However, the present invention may be embodied in different forms and variations, and should not be construed as being limited to the embodiments set forth herein. Rather, the described embodiments are provided so that this disclosure will be thorough and complete, and will fully convey the present invention to those skilled in the art to which this invention pertains. Throughout this disclosure, like reference numerals refer to like parts throughout the various figures and embodiments of the present invention.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, logic, interfaces, decoders, drivers, generators and other signal generating and signal processing features may include, for example, a memory or other storage device for storing code or instructions to be executed, for example, by a computer, processor, microprocessor, controller, or other signal processing device.

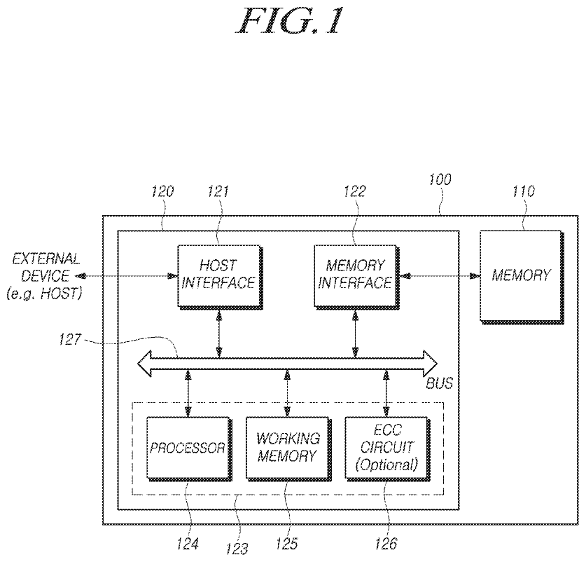

FIG. 1 is a schematic configuration diagram of a storage device 100 according to an embodiment of the present disclosure.

Referring to FIG. 1, the storage device 100 may include a memory 110 that stores data and a controller 120 that controls the memory 110.

The memory 110 includes a plurality of memory blocks, and operates under the control of the controller 120. Operations of the memory 110 may include, for example, a read operation, a program operation (also referred to as a write operation) and an erase operation.

The memory 110 may include a memory cell array including a plurality of memory cells (also simply referred to as “cells”) that store data. Such a memory cell array may exist in a memory block.

For example, the memory 110 may be realized in various types of memory such as a DDR SDRAM (double data rate synchronous dynamic random access memory), a LPDDR4 (low power double data rate 4) SDRAM, a GDDR (graphics double data rate) SDRAM, an LPDDR (low power DDR), a RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM) and a spin transfer torque random access memory (STT-RAM).

The memory 110 may be implemented as a three-dimensional array structure. For example, embodiments of this disclosure may be applied to a charge trap flash (CTF) in which a charge storage layer is configured by a dielectric layer, and a flash memory in which a charge storage layer is configured by a conductive floating gate.

The memory 110 may receive a command and an address from the controller 120 and may access an area in the memory cell array that is selected by the address. The memory 110 may perform an operation indicated by the command, on the area selected by the address.

The memory 110 may perform a program operation, a read operation or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 may control write (program), read, erase and background operations for the memory 110. For example, background operations may include at least one of a garbage collection (GC) operation, a wear leveling (WL) operation, a read reclaim (RR) operation, a bad block management (BBM) operation, and so forth.

The controller 120 may control the operation of the memory 110 according to a request from an external device (e.g., a host) located outside the storage device 100. The controller 120, however, also may control the operation of the memory 110 regardless or in the absence of a request of the host.

The host may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, a RFID (radio frequency identification) device, and a mobility device (e.g., a vehicle, a robot or a drone) capable of driving under human control or autonomous driving, as non-limiting examples. Alternatively, the host may be a virtual reality (VR) device providing 2D or 3D virtual reality images or an augmented reality (AR) device providing augmented reality images. The host may be any of various electronic devices that require the storage device 100 capable of storing data.

The host may include at least one operating system (OS). The operating system may generally manage and control the function and operation of the host, and may provide interoperability between the host and the storage device 100. The operating system may be classified into a general operating system and a mobile operating system depending on the mobility of the host.

The controller 120 and the host may be separated from each other, or the controller 120 and the host may be integrated into one device. Hereunder, for the sake of convenience, descriptions will describe the controller 120 and the host as being separated from each other.

Referring to FIG. 1, the controller 120 may include a memory interface 122, a control circuit 123, and a host interface 121.

The host interface 121 may provide an interface for communication with the host. For example, the host interface 121 may provide an interface that uses at least one of various communication standards or interfaces such as a USB (universal serial bus) protocol, a MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, a SCSI (small computer system interface) protocol, an ESDI (enhanced small disk interface) protocol, an IDE (integrated drive electronics) protocol and a private protocol.

When receiving a command from the host, the control circuit 123 may receive the command through the host interface 121, and may perform an operation of processing the received command.

The memory interface 122 may be coupled with the memory 110 to provide an interface for communication with the memory 110. That is, the memory interface 122 may provide an interface between the memory 110 and the controller 120 under the control of the control circuit 123.

The control circuit 123 may perform the general control operations of the controller 120 to control the operation of the memory 110. To this end, for instance, the control circuit 123 may include a processor 124, a working memory 125, and an error detection and correction circuit (ECC circuit) 126.

The processor 124 may control operations of the controller 120, and may perform a logic calculation. The processor 124 may communicate with the host through the host interface 121, and may communicate with the memory 110 through the memory interface 122.

The processor 124 may perform the function of a flash translation layer (FTL). The processor 124 may translate a logical block address (LBA), provided by the host, into a physical block address (PBA) through the flash translation layer (FTL). The flash translation layer (FTL) may receive the logical block address (LBA) and translate the logical block address (LBA) into the physical block address (PBA), by using a mapping table.

There are various address mapping methods of the flash translation layer, depending on a mapping unit. Representative address mapping methods include a page mapping method, a block mapping method and a hybrid mapping method.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be outputted to the host.

The processor 124 may execute firmware to control the operation of the controller 120. Namely, in order to control the general operation of the controller 120 and perform a logic calculation, the processor 124 may execute (drive) firmware loaded in the working memory 125 upon booting. Hereafter, an operation of the storage device 100 according to embodiments of this disclosure will be described as implementing a processor 124 that executes firmware in which the corresponding operation is defined.

Firmware, as a program to be executed in the storage device 100 to drive the storage device 100, may include various functional layers. For example, the firmware may include binary data in which codes for executing the functional layers, respectively, are defined.

For example, the firmware may include at least one of a flash translation layer (FTL) which performs a translating function between a logical address requested to the storage device 100 from the host and a physical address of the memory 110; a host interface layer (HIL) which serves to analyze a command requested to the storage device 100 as a storage device from the host and transfer the command to the flash translation layer (FTL); and a flash interface layer (FIL) which transfers a command instructed from the flash translation layer (FTL) to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logic calculation, which is defined in the firmware loaded in the working memory 125, to control the general operation of the controller 120. The processor 124 may store a result of performing the logic calculation defined in the firmware, in the working memory 125. The processor 124 may control the controller 120 according to a result of performing the logic calculation defined in the firmware such that the controller 120 generates a command or a signal. When a part of firmware, in which a logic calculation to be performed is defined, is stored in the memory 110, but not loaded in the working memory 125, the processor 124 may generate an event (e.g., an interrupt) for loading the corresponding part of the firmware into the working memory 125 from the memory 110.

The processor 124 may load metadata necessary for driving firmware from the memory 110. The metadata, which is data for managing the memory 110, may include for example management information on user data stored in the memory 110.

Firmware may be updated while the storage device 100 is manufactured or while the storage device 100 is operating. The controller 120 may download new firmware from the outside of the storage device 100 and update existing firmware with the new firmware.

To drive the controller 120, the working memory 125 may store necessary firmware, a program code, a command and data. The working memory 125 may be a volatile memory that includes, for example, at least one of a SRAM (static RAM), a DRAM (dynamic RAM) and a SDRAM (synchronous DRAM).

The error detection and correction circuit 126 may detect an error bit of target data, and correct the detected error bit by using an error correction code. The target data may be, for example, data stored in the working memory 125 or data read from the memory 110.

The error detection and correction circuit 126 may decode data by using an error correction code. The error detection and correction circuit 126 may be realized by various code decoders. For example, a decoder that performs unsystematic code decoding or a decoder that performs systematic code decoding may be used.

For example, the error detection and correction circuit 126 may detect an error bit by the unit of a set sector in each of the read data, when each read data is constituted by a plurality of sectors. A sector may mean a data unit that is smaller than a page, which is the read unit of a flash memory. Sectors constituting each read data may be matched with one another using an address.

The error detection and correction circuit 126 may calculate a bit error rate (BER), and may determine whether an error is correctable or not, by sector units. For example, when a bit error rate (BER) is higher than a reference value, the error detection and correction circuit 126 may determine that a corresponding sector is uncorrectable or a fail. On the other hand, when a bit error rate (BER) is lower than the reference value, the error detection and correction circuit 126 may determine that a corresponding sector is correctable or a pass.

The error detection and correction circuit 126 may perform an error detection and correction operation sequentially for all read data. In the case where a sector included in read data is correctable, the error detection and correction circuit 126 may omit an error detection and correction operation for a corresponding sector for next read data. If the error detection and correction operation for all read data is ended in this way, then the error detection and correction circuit 126 may detect a sector which is uncorrectable in read data last. There may be one or more sectors that are determined to be uncorrectable. The error detection and correction circuit 126 may transfer information (e.g., address information) regarding a sector which is determined to be uncorrectable to the processor 124.

A bus 127 may provide channels among the components 121, 122, 124, 125 and 126 of the controller 120. The bus 127 may include, for example, a control bus for transferring various control signals, commands and the like, a data bus for transferring various data, and so forth.

Some components among the above-described components 121, 122, 124, 125 and 126 of the controller 120 may be omitted, or some components among the above-described components 121, 122, 124, 125 and 126 of the controller 120 may be integrated into one component. In addition to the above-described components 121, 122, 124, 125 and 126 of the controller 120, one or more other components may be added.

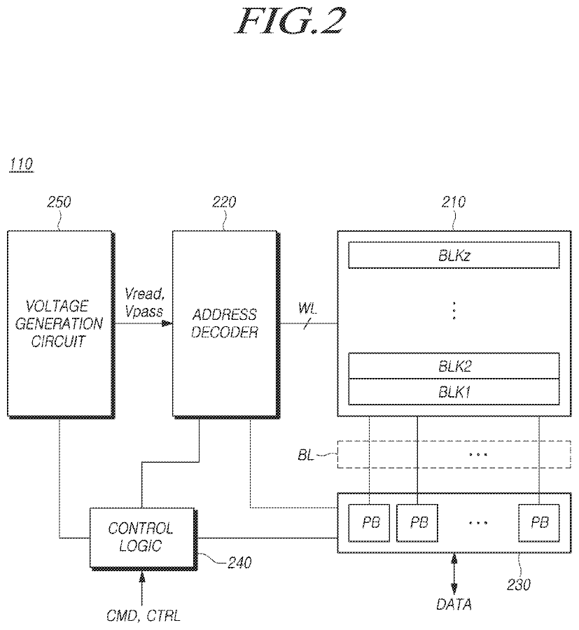

Hereinbelow, the memory 110 will be described in further detail with reference to FIG. 2.

FIG. 2 is a block diagram schematically illustrating the memory 110 of FIG. 1.

Referring to FIG. 2, the memory 110 may include a memory cell array 210, an address decoder 220, a read and write circuit 230, a control logic 240, and a voltage generation circuit 250.

The memory cell array 210 may include a plurality of memory blocks BLK1 to BLKz, where z is a natural number of 2 or greater.

In the plurality of memory blocks BLK1 to BLKz, a plurality of word lines WL and a plurality of bit lines BL may be disposed, and a plurality of memory cells (MC) may be arranged.

The plurality of memory blocks BLK1 to BLKz may be coupled with the address decoder 220 through the plurality of word lines WL. The plurality of memory blocks BLK1 to BLKz may be coupled with the read and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) capable of 1-bit data. In another instance, each of the plurality of memory cells included in the memory cell array 210 may be a multi-level cell (MLC) capable of 2-bit data. In still another instance, each of the plurality of memory cells included in the memory cell array 210 may be a triple level cell (TLC) capable of 3-bit data. In yet another instance, each of the plurality of memory cells included in the memory cell array 210 may be a quad level cell (QLC) capable of 4-bit data. In a further instance, the memory cell array 210 may include a plurality of memory cells, each of which stores 5 or more-bit data.

The number of bits of data stored in each of the plurality of memory cells may be dynamically determined. For example, a single-level cell capable of 1-bit data may be changed to a triple-level cell capable of 3-bit data.

Referring to FIG. 2, the address decoder 220, the read and write circuit 230, the control logic 240 and the voltage generation circuit 250 may operate as a peripheral circuit that drives the memory cell array 210.

The address decoder 220 may be coupled to the memory cell array 210 through the plurality of word lines WL.

The address decoder 220 may operate under the control of the control logic 240.

The address decoder 220 may receive an address through an input/output buffer in the memory 110. The address decoder 220 may decode a block address in the received address. The address decoder 220 may select at least one memory block depending on the decoded block address.

The address decoder 220 may receive a read voltage Vread and a pass voltage Vpass from the voltage generation circuit 250.

The address decoder 220 may apply the read voltage Vread to a selected word line WL in a selected memory block during a read operation, and may apply the pass voltage Vpass to the remaining unselected word lines WL.

The address decoder 220 may apply a verify voltage generated in the voltage generation circuit 250 to a selected word line WL in a selected memory block in a program verify operation, and may apply the pass voltage Vpass to the remaining unselected word lines WL.

The address decoder 220 may decode a column address in the received address. The address decoder 220 may transmit the decoded column address to the read and write circuit 230.

A read operation and a program operation of the memory 110 may be performed by the unit of a page. An address received when a read operation or a program operation is requested may include at least one of a block address, a row address and a column address.

The address decoder 220 may select one memory block and one word line depending on a block address and a row address. A column address may be decoded by the address decoder 220 and be provided to the read and write circuit 230.

The address decoder 220 may include at least one of a block decoder, a row decoder, a column decoder and an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that take charge of a data processing function, and may further include cache buffers that take charge of a caching function.

The plurality of page buffers PB may be coupled to the memory cell array 210 through the plurality of bit lines BL, respectively. The plurality of page buffers PB may continuously supply sensing current to bit lines BL coupled with memory cells to sense threshold voltages (Vth) of the memory cells in a read operation and a program verify operation, and may latch sensing data by sensing through sensing nodes, changes in the amounts of current flowing, depending on the programmed states of the corresponding memory cells.

The read and write circuit 230 may operate in response to page buffer control signals outputted from the control logic 240.

In a read operation, the read and write circuit 230 temporarily stores read data by sensing data of memory cells, and then, outputs data DATA to the input/output buffer of the memory 110. In an embodiment, the read and write circuit 230 may include a column select circuit in addition to the page buffers PB or the page registers.

The control logic 240 may be coupled with the address decoder 220, the read and write circuit 230, and the voltage generation circuit 250. The control logic 240 may receive a command CMD and a control signal CTRL through the input/output buffer of the memory 110.

The control logic 240 may control operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal outputted from the control logic 240.

Each memory block of the memory 110 described above may be configured by a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. In another example, each of the plurality of word lines WL may be disposed in a column direction, and each of the plurality of bit lines BL may be disposed in a row direction.

A memory cell may be coupled to one of the plurality of word lines WL and one of the plurality of bit lines BL. A transistor may be disposed in each memory cell.

For example, a transistor disposed in each memory cell (MC) may include a drain, a source and a gate. The drain (or source) of the transistor may be coupled with a corresponding bit line BL directly or via another transistor. The source (or drain) of the transistor may be coupled with a source line (which may be the ground) directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line more adjacent to the read and write circuit 230 between two outermost word lines, and a second select line (also referred to as a drain select line or a source select line) may be additionally disposed outside a second outermost word line between the two outermost word lines.

At least one dummy word line may be additionally disposed between the first outermost word line and the first select line. At least one dummy word line may also be additionally disposed between the second outermost word line and the second select line.

A read operation and a program operation (write operation) of the memory block described above may be performed by the unit of a page, and an erase operation may be performed by the unit of a memory block.

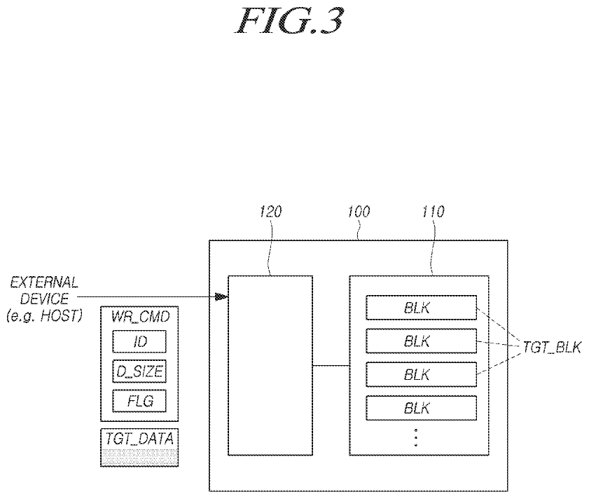

FIG. 3 illustrates an operation in which the storage device 100 processes write command WR_CMD according to embodiments of the present disclosure.

Referring to FIG. 3, the storage device 100 may include the memory 110 and the controller 120.

The memory 110 may include a plurality of memory blocks BLK. Data may be stored in the plurality of memory blocks BLK.

The controller 120 may receive the write command WR_CMD from the outside of the storage device 100. The write command WR_CMD is a command requesting writing of target data TGT_DATA. The write command WR_CMD may be transmitted from an external device (e.g., a host HOST) located outside the storage device 100.

The write command WR_CMD may include i) an identifier ID for the target data TGT_DATA, ii) a size D_SIZE of the target data TGT_DATA, and iii) a flag FLG indicating that the target data TGT_DATA is cold data.

The identifier ID may be used to identify information required for an operation of reading or writing the target data TGT_DATA.

For example, the identifier ID may be an inode number corresponding to the target data TGT_DATA. The inode number is a value used to identify an inode including metadata of a file corresponding to the target data TGT_DATA in a file system (e.g., F2FS file system) that manages the file corresponding to the target data TGT_DATA. A user may access the file through the name of the file, and information about the file in the file system may be accessed through the inode number.

The size D_SIZE of the target data TGT_DATA may be used to determine the number of memory blocks in which the target data TGT_DATA is stored among the plurality of memory blocks BLK.

The flag FLG may be used to identify that the target data TGT_DATA is cold data. The controller 120 may recognize that the target data TGT_DATA is cold data through the flag FLG, and may write the target data TGT_DATA in consideration of the characteristics of cold data.

When receiving the write command WR_CMD, the controller 120 may write the target data TGT_DATA to target memory blocks TGT_BLK among the plurality of memory blocks BLK. In this case, the target memory blocks TGT_BLK may be consecutive.

When the target memory blocks TGT_BLK are consecutive, the physical addresses respectively corresponding to the target memory blocks TGT_BLK may be consecutive to each other. Accordingly, the physical addresses respectively corresponding to the target memory blocks TGT_BLK may be represented as one physical address area.

In embodiments of the present disclosure, the controller 120 may write the target data TGT_DATA, which is cold data, to target memory blocks TGT_BLK that are consecutive to each other, thereby obtaining following effects.

As described above, the flag FLG of the write command WR_CMD may indicate that the target data TGT_DATA is cold data. Since cold data is unlikely to be modified after being written once, the target data TGT_DATA may be easily managed through target memory blocks TGT_BLK that are consecutive to each other.

For example, when an erase operation on the target memory blocks TGT_BLK is executed, since the target memory blocks TGT_BLK can be erased at once, free memory blocks can be easily secured during garbage collection and victim blocks can be selected collectively. Through this, the efficiency of the garbage collection can be improved.

As another example, performance of write operation on the target data TGT_DATA may be improved by sequentially writing the target data TGT_DATA, which is cold data, to the target memory blocks TGT_BLK. Also, by sequentially reading the target data TGT_DATA from the target memory blocks TGT_BLK, performance of read operation for the target data TGT_DATA can be improved.

Hereinafter, an operation in which the storage device 100 writes the target data TGT_DATA based on the write command WR_CMD will be described in detail.

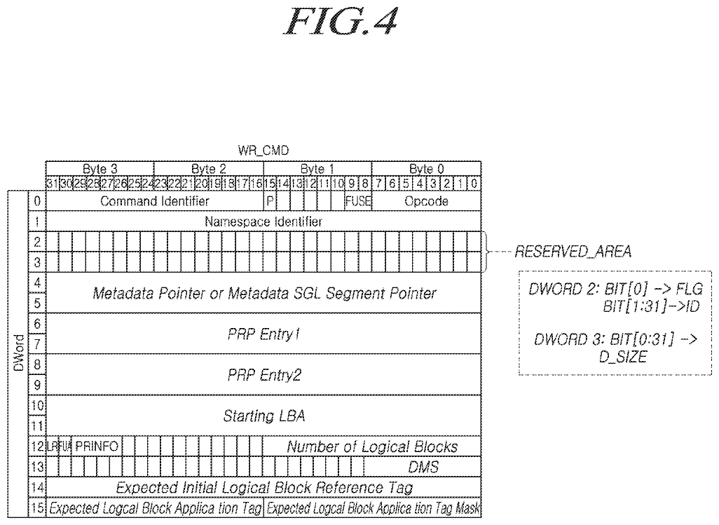

FIG. 4 illustrates an example of write command WR_CMD according to embodiments of the present disclosure.

Referring to FIG. 4, the identifier ID, the size D_SIZE of the target data TGT_DATA and the flag FLG which are included in the write command WR_CMD may be included in a reserved area RESERVED_AREA of the write command WR_CMD. The reserved area RESERVED_AREA may not be used in a general command transmitted from the host HOST.

In FIG. 4, fields DWORD #2 and DWORD #3 of the write command WR_CMD may be the reserved area RESERVED_AREA. For example, the identifier ID, the size D_SIZE of the target data TGT_DATA, and the flag FLG may be included in the fields DWORD #2 and DWORD #3 of the write command WR_CMD.

For example, bit 0 of the field DWORD #2 may be allocated to the flag FLG, bits 1 to 31 of the field DWORD #2 may be allocated to the identifier ID, and bits 0 to 31 of the field DWORD #3 may be allocated to the size D_SIZE of the target data TGT_DATA. However, a specific method of mapping the identifier ID, the size D_SIZE of the target data TGT_DATA, and the flag FLG to the reserved area RESERVED_AREA is not limited by the embodiments of FIG. 4.

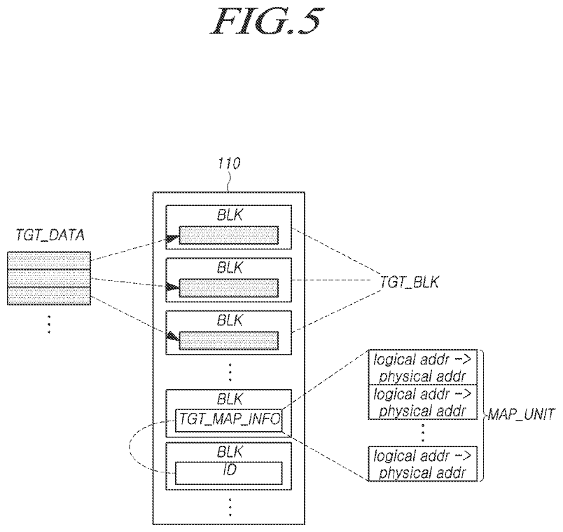

FIG. 5 illustrates an operation in which the storage device 100 writes target data TGT_DATA according to embodiments of the present disclosure.

Referring to FIG. 5, the controller 120 of the storage device 100 may sequentially write target data TGT_DATA to the target memory blocks TGT_BLK. For example, the controller 120 may write the target data TGT_DATA to the target memory blocks TGT_BLK in an ascending order or descending order of logical addresses corresponding to the target data TGT_DATA.

The controller 120 may also determine target map information TGT_MAP_INFO indicating mapping information between a logical address and a physical address for the target data TGT_DATA.

The target map information TGT_MAP_INFO may include a plurality of map units MAP_UNIT. Each of the plurality of map units MAP_UNIT may indicate a mapping relationship between a logical address and a physical address. For example, each of the plurality of map units MAP_UNIT may be a pair of one logical address and one physical address.

Also, the controller 120 may map the aforementioned identifier ID to the target map information TGT_MAP_INFO.

For example, the controller 120 may manage a table which manages pairs of a specific key and data corresponding to the key. The controller 120 may add a pair of the identifier ID and target map information TGT_MAP_INFO to the table.

The identifier ID and the target map information TGT_MAP_INFO may be stored in the memory 110. In FIG. 4, the case where the identifier ID and the target map information TGT_MAP_INFO are stored in different memory blocks is described as an example, but the identifier ID and the target map information TGT_MAP_INFO may be stored in the same memory block.

In addition, in FIG. 4, the case where the identifier ID and the target map information TGT_MAP_INFO are stored in a memory block other than the target memory blocks TGT_BLK is described as an example, but the identifier ID and the target map information TGT_MAP_INFO may be stored in the target memory blocks TGT_BLK like the target data TGT_DATA.

In the above, an operation of storage device 100 writing the target data TGT_DATA based on the write command WR_CMD has been described.

Hereinafter, an operation of reading the written target data TGT_DATA by the storage device 100 will be described.

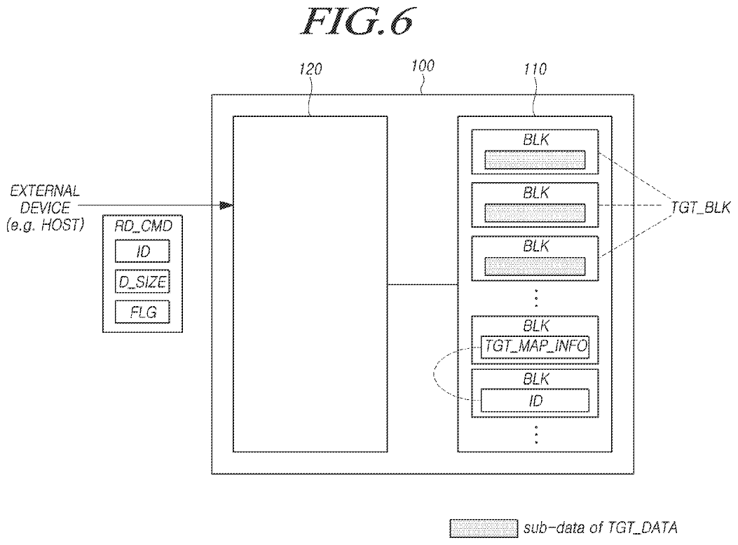

FIG. 6 illustrates an operation in which the storage device 100 processes a read command RD_CMD according to embodiments of the present disclosure.

Referring to FIG. 6, the controller 120 of the storage device 100 may receive a read command RD_CMD. The read command RD_CMD is a command requesting to read the target data TGT_DATA stored in the target memory blocks TGT_BLK.

The read command RD_CMD may also include the identifier ID, the size D_SIZE of the target data TGT_DATA, and the flag FLG like the write command WR_CMD. The location of the identifier ID, the size D_SIZE of the target data TGT_DATA, and the flag FLG on the read command RD_CMD and the location of the identifier ID, the size D_SIZE of the target TGT_DATA, and the flag FLG on the write command WR_CMD may be the same.

When receiving the read command RD_CMD, the controller 120 may read the target data TGT_DATA from the target memory blocks TGT_BLK based on the target map information TGT_MAP_INFO mapped to the identifier ID.

The read command RD_CMD may include the identifier ID, and the memory 110 may store the target map information TGT_MAP_INFO mapped to the identifier ID. Accordingly, target map information TGT_MAP_INFO may be obtained based on the read command RD_CMD.

As described above with reference to FIG. 5, since the target map information TGT_MAP_INFO indicates mapping information between a logical address and a physical address for the target data TGT_DATA, the controller 120 may sequentially read the target data TGT_DATA based on the target map information TGT_MAP_INFO. Through this, performance of the storage device 100 reading the target data TGT_DATA may increase.

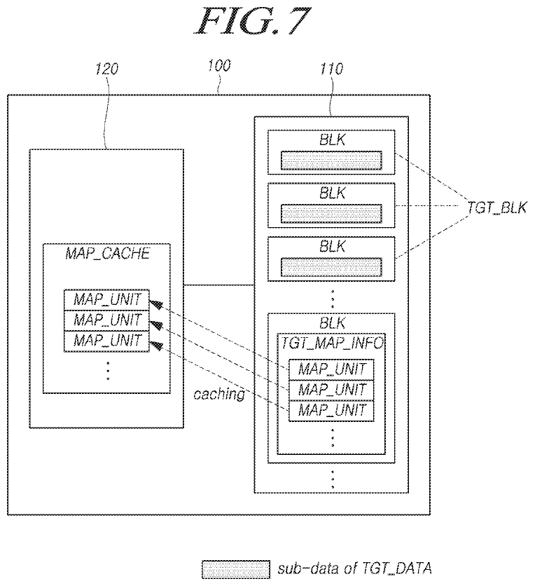

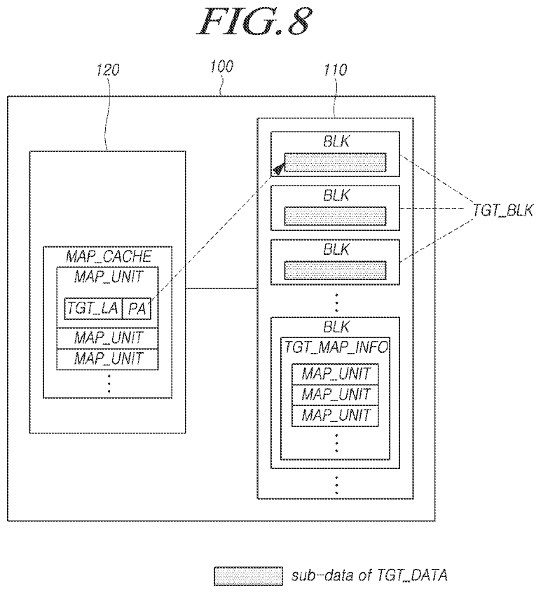

FIGS. 7 and 8 illustrate an operation in which the storage device 100 reads target data TGT_DATA according to embodiments of the present disclosure.

Referring to FIG. 7, the controller 120 of the storage device 100 may cache a plurality of map units MAP_UNIT included in the target map information TGT_MAP_INFO in a map cache MAP_CACHE.

The map cache MAP_CACHE is an area capable of caching information about a mapping relationship between logical address and physical address. Since each of the plurality of map units MAP_UNIT indicates a mapping relationship between a logical address and a physical address, the plurality of map units MAP_UNIT may be cached in the map cache MAP_CACHE.

The map cache MAP_CACHE may be set in the working memory 125 of the controller 120 or may be set in a separate volatile memory included in the controller 120.

After the plurality of map units MAP_UNIT are cached in the map cache MAP_CACHE, the controller 120 may search the map cache MAP_CACHE for a map unit corresponding to a specific logical address.

The controller 120 may obtain a physical address at which sub-data corresponding to the logical address is stored based on the searched map unit. The controller 120 may read the sub-data stored in an area indicated by the physical address.

Referring to FIG. 8, the controller 120 may search for a map unit corresponding to a target logical address TGT_LA from among the map units MAP_UNIT cached in the map cache MAP_CACHE.

Among the target data TGT_DATA, the controller 120 may read, from the target memory blocks TGT_BLK, the sub-data corresponding to the target logical address TGT_LA based on the map unit corresponding to the target logical address TGT_LA. The sub-data corresponding to the target logical address TGT_LA is stored in an area indicated by the physical address PA mapped to the target logical address TGT_LA.

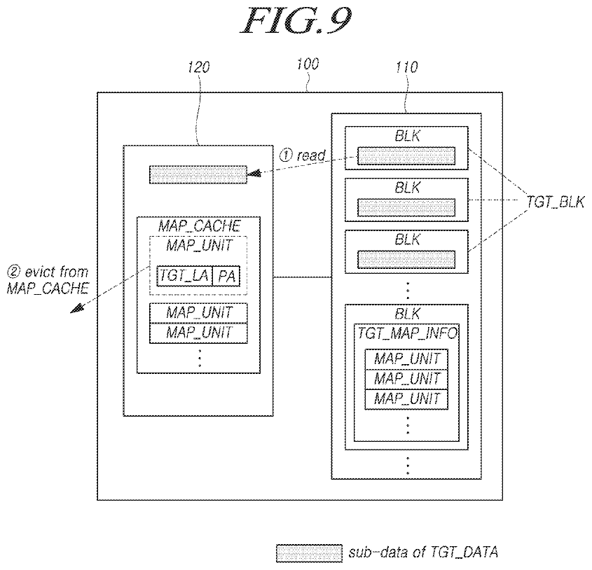

FIG. 9 illustrates an operation in which the storage device 100 evicts a map unit cached in a map cache MAP_CACHE according to embodiments of the present disclosure.

Referring to FIG. 9, the controller 120 may read, from the target memory blocks TGT_BLK, the sub-data corresponding to the target logical address TGT_LA out of the target data TGT_DATA based on the map unit corresponding to the target logical address TGT_LA (\textcircled{1}). The read sub-data may be stored in the controller 120 (e.g., the working memory 125).

Then, when the operation of reading the part corresponding to the target logical address TGT_LA out of the target data TGT_DATA is completed, the controller 120 may evict the map unit corresponding to the target logical address TGT_LA from the map cache MAP_CACHE (\textcircled{2}).

Since the target data TGT_DATA is cold data, it is unlikely that a part read once from the target data TGT_DATA will be read again in the near future. Accordingly, the free space of the map cache MAP_CACHE may be secured by evicting the map unit corresponding to the part read once from the map cache MAP_CACHE.

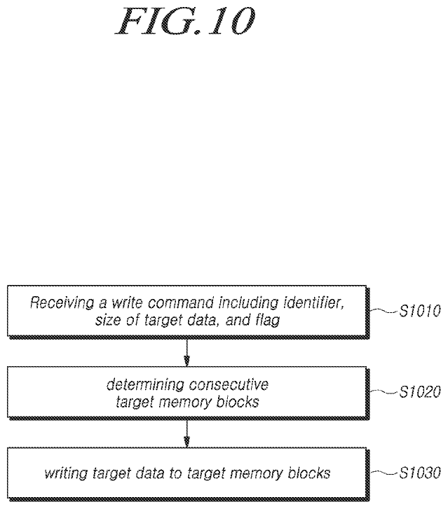

FIG. 10 is a flowchart for describing an operating method of the storage device 100 according to embodiments of the present disclosure.

Referring to FIG. 10, the method of operating the storage device 100 may include receiving a write command WR_CMD which requests to write target data TGT_DATA (S1010). The write command WR_CMD may include an identifier ID for the target data TGT_DATA, a size D_SIZE of the target data TGT_DATA and a flag FLG indicating that the target data TGT_DATA is cold data.

In this case, the identifier ID, the size D_SIZE of the target data TGT_DATA, and the flag FLG may be included in reserved area RESERVED_AREA of the write command.

For example, the identifier ID may be the inode number corresponding to the target data TGT_DATA.

The method of operating the storage device 100 may include determining, when the write command WR_CMD is received, consecutive target memory blocks TGT_BLK among the plurality of memory blocks BLK (S1020).

The method of operating the storage device 100 may include writing the target data TGT_DATA to the target memory blocks TGT_BLK (S1030).

For example, the operation S1030 may include sequentially writing the target data TGT_DATA to the target memory blocks TGT_BLK, determining target map information TGT_MAP_INFO indicating mapping information between a logical address and a physical address for the target data TGT_DATA, and mapping the identifier ID to target map information TGT_MAP_INFO. In this case, the target map information TGT_MAP_INFO may include a plurality of map units MAP_UNIT each indicating a mapping relationship between one logical address and one physical address.

The method of operating the storage device 100 may further include receiving a read command RD_CMD which requests to read the target data TGT_DATA and includes the identifier ID, the size D_SIZE of the target data TGT_DATA and the flag FLG, reading the target data TGT_DATA from the target memory blocks TGT_BLK based on the target map information TGT_MAP_INFO mapped to the identifier ID.

The reading the target data TGT_DATA from the target memory blocks TGT_BLK may include caching the plurality of map units MAP_UNIT included in the target map information TGT_MAP_INFO in a map cache MAP_CACHE, and reading, based on a map unit corresponding to a target logical address TGT_LA among map units MAP_UNIT cached in the map cache MAP_CACHE, sub-data from the target memory blocks TGT_BLK, the sub-data corresponding to the target logical address TGT_LA among the target data TGT_DATA.

The reading the target data may further include evicting the map unit corresponding to the target logical address TGT_LA from the map cache MAP_CACHE when the reading of the sub-data corresponding to the target logical address TGT_LA from the target memory blocks TGT_BLK is completed.

Although embodiments of the present disclosure have been described for illustrative purposes, those skilled in the art will appreciate that various modifications, additions and substitutions are possible, without departing from the scope and spirit of the present disclosure. Therefore, the embodiments disclosed above and in the accompanying drawings should be considered in a descriptive sense only and not for limiting the technological scope. The technological scope of the present disclosure is not limited by the embodiments and the accompanying drawings. The spirit and scope of the present disclosure should be interpreted in connection with the appended claims and encompass all equivalents falling within the scope of the appended claims. Furthermore, the embodiments may be combined to form additional embodiments.

What is claimed is:

1. A storage device comprising:
a memory including a plurality of memory blocks; and
a controller configured to write target data to consecutive target memory blocks among the plurality of memory blocks, when receiving a write command which requests to write the target data and includes an identifier for the target data, a size of the target data, and a flag indicating that the target data is cold data.

2. The storage device according to claim 1, wherein the identifier, the size of the target data, and the flag are included in reserved area of the write command.

3. The storage device according to claim 1, wherein the identifier is an inode number corresponding to the target data.

4. The storage device according to claim 1,
wherein the controller writes the target data by:
sequentially writing the target data to the target memory blocks;
determining target map information indicating mapping information between a logical address and a physical address for the target data; and
mapping the identifier to the target map information, and
wherein the target map information includes a plurality of map units each map unit indicating a mapping relationship between one logical address and one physical address.

5. The storage device according to claim 1, wherein the controller is further configured to read the target data from the target memory blocks based on the target map information mapped to the identifier, when receiving a read command which includes the identifier, the size of the target data, and the flag.

6. The storage device according to claim 5, wherein the controller reads the target data by:
caching the plurality of map units included in the target map information in a map cache, and
reading, based on a map unit corresponding to a target logical address among the cached map units, sub-data from the target memory blocks, the sub-data corresponding to the target logical address among the target data.

7. The storage device according to claim 6, wherein the controller reads the target data further by evicting the map unit corresponding to the target logical address from the map cache when the reading of the sub-data is completed.

8. A method for operating a storage device, the method comprising:
receiving a write command which requests to write target data and includes an identifier for target data, a size of the target data and a flag indicating that the target data is cold data;
determining consecutive target memory blocks among the plurality of memory blocks; and
writing the target data to the target memory blocks.

9. The method according to claim 8, wherein the identifier, the size of the target data, and the flag are included in reserved area of the write command.

10. The method according to claim 8, wherein the identifier is an inode number corresponding to the target data.

11. The method according to claim 8,
wherein the writing the target data to the target memory blocks includes:
sequentially writing the target data to the target memory blocks;
determining target map information indicating mapping information between a logical address and a physical address for the target data; and
mapping the identifier to the target map information, and
wherein the target map information includes a plurality of map units, each map unit indicating a mapping relationship between one logical address and one physical address.

12. The method according to claim 11, further comprising:
receiving a read command which includes the identifier, the size of the target data and the flag; and
reading the target data from the target memory blocks based on the target map information mapped to the identifier.

13. The method according to claim 12, wherein the reading the target data from the target memory blocks includes:
caching the plurality of map units included in the target map information in a map cache; and
reading, based on a map unit corresponding to a target logical address among the cached map units, sub-data from the target memory blocks, the sub-data corresponding to the target logical address among the target data.

14. The method according to claim 13, wherein the reading the target data further includes evicting the map unit corresponding to the target logical address from the map cache when the reading of the sub-data is completed.

15. An operating method of a controller, the operating method comprising controlling, in response to an access request for target data, a memory device to access consecutive memory blocks related to the target data,
wherein the access request includes an indication that the target data is cold data.
